(19) United States
(12) Patent Application Publication
(10) Pub. No.: US 2014/0168223 A1
(43) Pub. Date: Jun. 19, 2014

(54) PIXEL ACTUATION VOLTAGE TUNING

(71) Applicant: QUALCOMM MEMS TECHNOLOGIES, INC., San Diego, CA (US)

(72) Inventors: Yi Tao, San Jose, CA (US); Fan Zhong, Fremont, CA (US)

(73) Assignee: QUALCOMM MEMS Technologies, Inc., San Diego, CA (US)

(21) Appl. No.: 13/714,047

(22) Filed: Dec. 13, 2012

(51) Int. Cl. G02B 26/00; G06T 1/00

(52) U.S. Cl. CPC G02B 26/001; G06T 1/00
USPC 345/501; 359/290; 427/58

(57) ABSTRACT

This disclosure provides systems, methods and apparatus for electromechanical systems displays. In one aspect, the display can include a plurality of electromechanical display elements including a first set of electromechanical display elements and a second set of electromechanical display elements. Each electromechanical display element can include a common electrode and a segment electrode. Each of the segment electrodes of the first set of electromechanical display elements can have a first area located under the common electrodes of the first set. Each of the segment electrodes of the second set of electromechanical display elements can have a second area smaller than the first area located under the common electrodes of the second set. In some implementations, an actuation voltage of each electromechanical display element of the first set is approximately the same as an actuation voltage of each electromechanical display element of the second set.

### TECHNICAL FIELD

This disclosure relates to electromechanical systems and devices, and in particular, to methods and apparatus for matching actuation voltages of display elements in a display.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

To induce the relative motion between the conductive plates, a particular actuation voltage may be applied across the plates to cause the plates to move toward or away from one other. In general, the actuation voltage for a particular display element can be based on various geometric or structural features of the display element. It should be appreciated, therefore, that display elements having different structures or geometries may likewise have different actuation voltages. In some arrangements, it can be desirable to match actuation voltages among display elements that have different geometries and/or structures.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display apparatus. The display apparatus can include a plurality of electromechanical display elements including a first set of electromechanical display elements and a second set of electromechanical display elements. Each electromechanical display element can include a common electrode and a segment electrode. Each of the segment electrodes of the first set of electromechanical display elements can have a first area located under the common electrodes of the first set. Each of the segment electrodes of the second set of electromechanical display elements can have a second area smaller than the first area located under the common electrodes of the second set.

In some implementations, each electromechanical display element can be associated with an actuation voltage. The actuation voltage of each electromechanical display element of the first set can be approximately the same as the actuation voltage of each electromechanical display element of the second set. Each electromechanical display element can have an aperture. Further, the aperture of each electromechanical display element in the first set can have a larger area than the aperture of each electromechanical display element in the second set. The electromechanical display elements in the first and second sets can be configured to display substantially the same color. For example, in some implementations, the electromechanical display elements in the first and second sets can be configured to display green. Furthermore, the plurality of electromechanical display elements may include one or more interferometric modulators (IMODs) in various implementations. In some implementations, the plurality of electromechanical display elements may form a passive matrix array. In other implementations, the plurality of electromechanical display elements may form an active matrix array.

Another innovative aspect of the subject matter described in this disclosure can be implemented in a method of manufacturing a display. The method can include depositing an optically opaque mask layer on a substrate to define a plurality of apertures by edge contours of the mask layer. The method can further include depositing segment electrodes over the mask layer and the apertures. The segment electrodes can have edge contours that are different to define sets of physically different apertures.

In some implementations, a first set of apertures can be defined in the mask layer. Each aperture in the first set can have a first area. A second set of apertures also can be defined in the mask layer. Each aperture in the second set can have a second area smaller than the first area. In some implementations, the edge contours of first portions of the segment electrodes overlying apertures of the first set can be defined. The edge contours of second portions of the segment electrodes overlying apertures of the second set also can be defined such that the first portions of the segment electrodes have a larger area than the second portions of the segment electrodes.

Another innovative aspect of the subject matter described in this disclosure can be implemented in a display apparatus. The display apparatus can include a plurality of means for displaying image data. The displaying means can include means for forming apertures having different sizes. Further, the displaying means can include means for reducing a disparity in an actuation voltage associated with the differently-sized apertures, the actuation voltage being configured to actuate the displaying means from an unactuated state to an actuated state.

In some implementations, the aperture-forming means includes an optically opaque mask layer deposited on a substrate to define the differently-sized apertures by edge contours of the mask layer. Further, the disparity-reducing means can include segment electrodes deposited over the mask layer and the apertures, the segment electrodes having edge contours that are shaped differently for differently-sized apertures.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays (LCDs), organic light-emitting diode (OLED) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIGS. 3A-3E are cross-sectional illustrations of varying implementations of IMOD display elements. In particular, FIG. 3D is a cross-section showing the layers of the example display elements shown in FIGS. 9A and 9B.

FIG. 4 is a flow diagram illustrating a manufacturing process for an IMOD display or display element.

FIGS. 5A-5E are cross-sectional illustrations of various stages in a process of making an IMOD display or display element.

FIGS. 6A and 6B are schematic exploded partial perspective views of a portion of an electromechanical systems (EMS) package including an array of EMS elements and a backplate.

FIG. 7 is a top plan view of an example patterned mask layer that defines an array of display elements, according to one implementation.

FIG. 8 is a graph plotting examples of actuation voltages of green display elements having two different aperture areas on the vertical axis, versus thicknesses of a support layer and a sacrificial layer on the horizontal axis.

FIG. 9A is a top plan view of an example display element having a segment electrode layer disposed over a mask layer.

FIG. 9B is a top plan view of the example display element of FIG. 9A with a segment electrode layer having a smaller area associated with the display element than the segment electrode layer shown in FIG. 9A.

FIG. 10A is a flow diagram illustrating an example method of manufacturing a display.

FIG. 10B is a flow diagram illustrating another example method of manufacturing a display.

FIG. 11 is a graph plotting actuation voltage of a display element versus the radius of a notch formed in an example segment electrode layer associated with the display element.

FIG. 12 is a graph plotting the air gap versus applied voltage for three different example green display elements.

FIGS. 13A and 13B are system block diagrams illustrating an example display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Various implementations disclosed herein may be directed to matching actuation voltages in display elements that have different geometries or structures. For example, in some implementations, display elements may have different aperture areas. The different aperture areas associated with the display elements can result in different actuation voltages for the display elements. In various pixel schemes, the resulting differences in actuation voltages may introduce image artifacts in the images to be displayed. For example, if two green display elements have different aperture sizes, applying the same voltage across the two green display elements may result in the display of slightly different colors, which can produce a striped pattern on the display in various arrangements. In some other arrangements, other types of artifacts may be present when two display elements configured to display the same color have different actuation voltages. To reduce the image artifacts, it can be desirable to match the actuation voltages associated with the two green display elements that have differently-sized apertures.

In some implementations, actuation voltages for display elements may be matched by having different area segment electrodes associated with different display elements. Returning to the example of the two green display elements having apertures with different areas, the segment electrode associated with one of the green display elements may be cut, or otherwise modified, to reduce the area of the segment electrode positioned below the common electrode for that particular display element relative to another display element. Reducing the area of the associated segment electrode may increase the actuation voltage for the one green display element to match the actuation voltage for the other green display element.

Particular implementations of the subject matter described in this disclosure can be implemented to realize one or more of the following potential advantages. For example, modifying the area of the segment electrode below the common electrode for a particular display element can accordingly modify the actuation voltage for that display element. If the area of the modified segment electrode is selected appropriately, then the actuation voltage for the display element may approximately match the actuation voltage of another display element having a segment electrode with an unmodified area (such as an uncut segment electrode). By matching actuation voltages for various sets of display elements (such as display elements configured to display the same color in some implementations), image artifacts associated with the differing actuation voltages may be reduced or eliminated. Other methods for matching actuation voltages by creating different structures for different display elements often modify the color associated with the different display elements. Matching actuation voltages for two different display elements configured to display the same color may require additional color tuning, which can accordingly increase the complexity of processing sequences. In contrast, modifying the area of the segment electrode can reduce actuation voltage differences without affecting display element color significantly.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

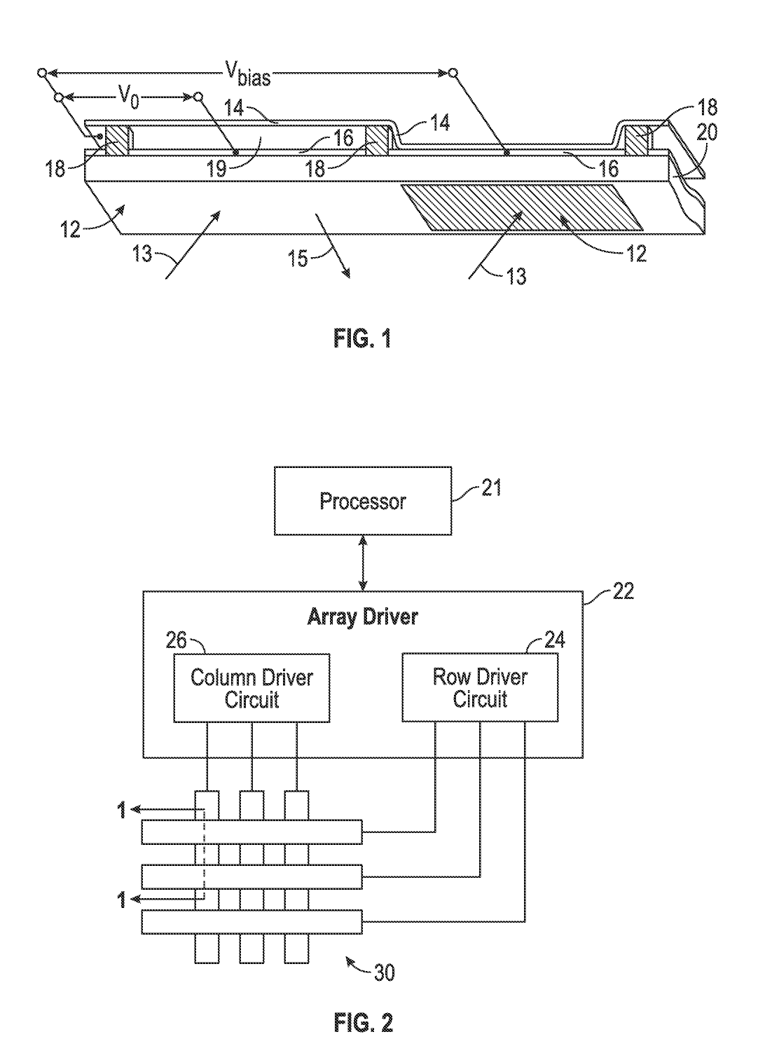

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

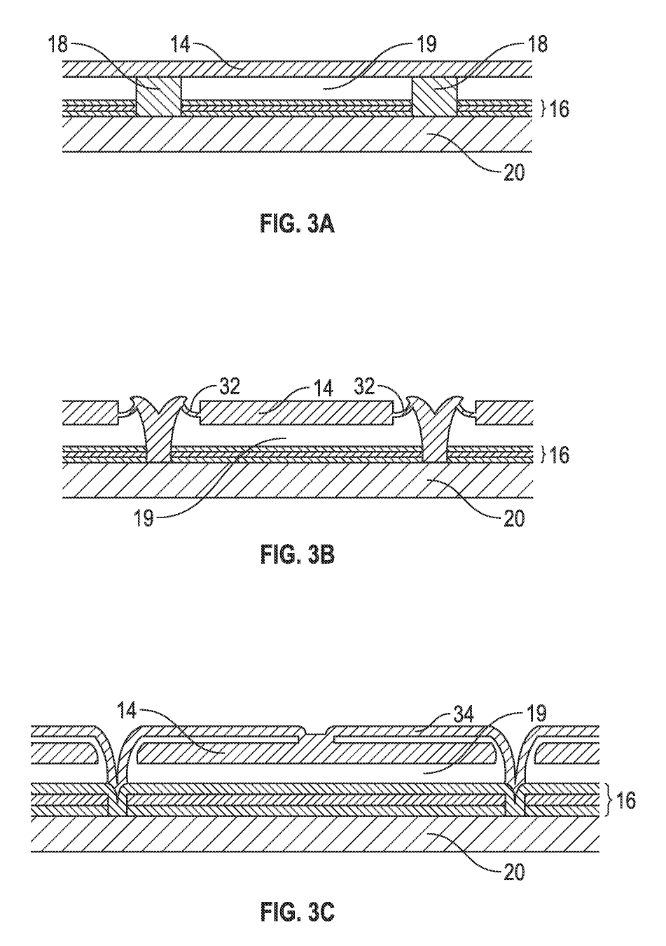

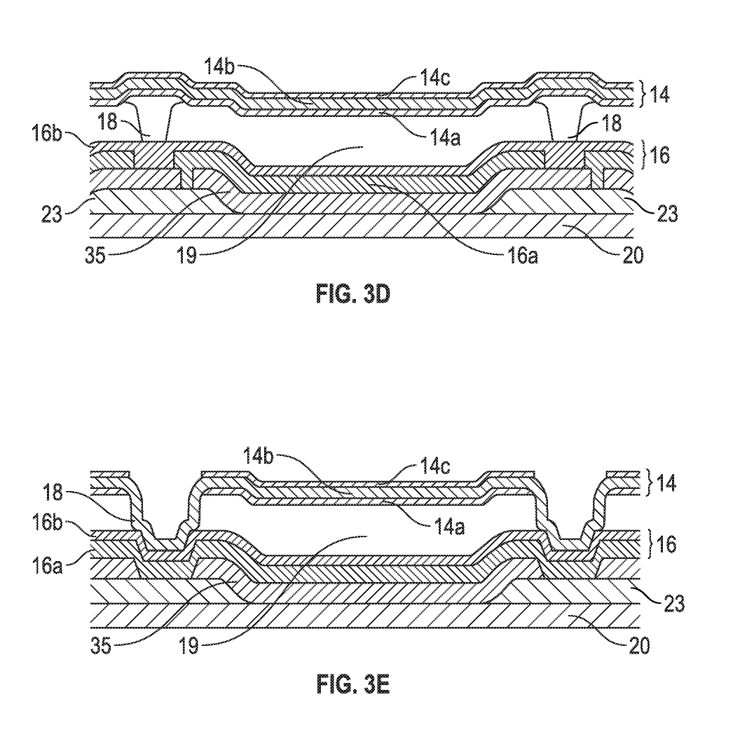

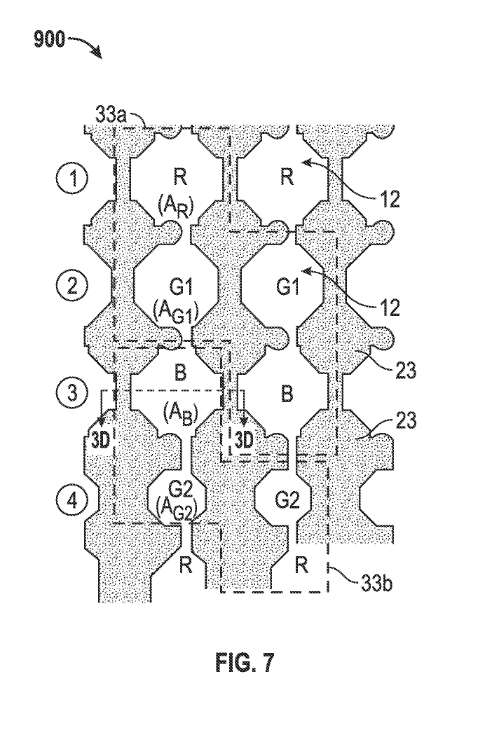

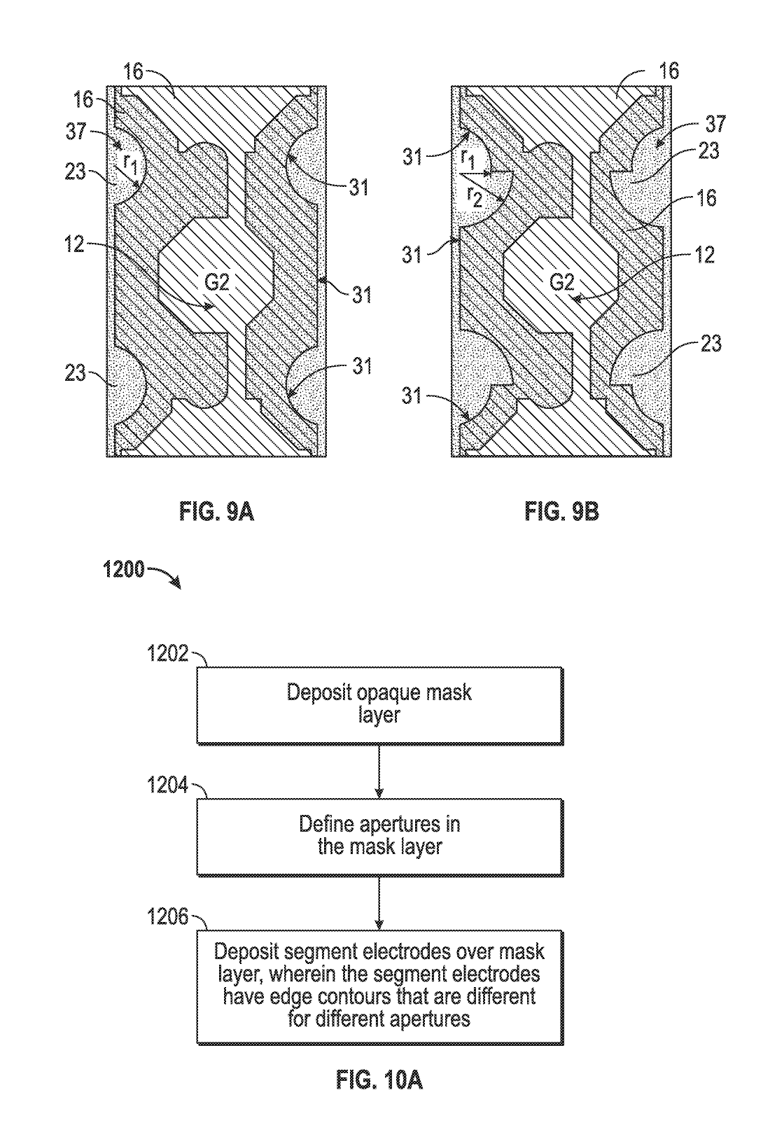

The details of the structure of IMOD displays and display elements may vary widely. FIGS. 3A-3E are cross-sectional illustrations of varying implementations of IMOD display elements. In particular, FIG. 3D is a cross-section showing the layers of the example display elements shown in FIGS. 7, 9A and 9B. FIG. 3A is a cross-sectional illustration of an IMOD display element, where a strip of metal material is deposited on supports 18 extending generally orthogonally from the substrate 20 forming the movable reflective layer 14. In FIG. 3B, the movable reflective layer 14 of each IMOD display element is generally square or rectangular in shape and attached to supports at or near the corners, on tethers 32. In FIG. 3C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as implementations of “integrated” supports or support posts 18. The implementation shown in FIG. 3C has additional benefits deriving from the decoupling of the optical functions of the movable reflective layer 14 from its mechanical functions, the latter of which are carried out by the deformable layer 34. This decoupling allows the structural design and materials used for the movable reflective layer 14 and those used for the deformable layer 34 to be optimized independently of one another.

FIG. 3D is another cross-sectional illustration of an IMOD display element, where the movable reflective layer 14 includes a reflective sub-layer 14a. The movable reflective layer 14 rests on a support structure, such as support posts 18. The support posts 18 provide separation of the movable reflective layer 14 from the lower stationary electrode, which can be part of the optical stack 16 in the illustrated IMOD display element. For example, a gap 19 is formed between the movable reflective layer 14 and the optical stack 16, when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a and 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 3D, some implementations also can include a black mask structure 23, or dark film layers, which also may be referred to herein as a mask layer 23. The black mask structure 23 can be formed in optically inactive regions (such as between display elements or under the support posts 18) to absorb ambient or stray light. The black mask structure 23 also can improve the optical properties of a display device by inhibiting light from being reflected from or transmitted through inactive portions of the display, thereby increasing the contrast ratio. The black mask structure or mask layer 23 may thereby define the outlines of the display elements 12, as explained herein with respect to the top plan views shown in FIGS. 7 and 9A-9B. Additionally, at least some portions of the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. In some implementations, the black mask structure 23 can be an etalon or interferometric stack structure. For example, in some implementations, the interferometric stack black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, tetrafluoromethane (or carbon tetrafluoride, CF₄) and/or oxygen (O₂) for the MoCr and SiO₂ layers and chlorine (Cl₂) and/or boron trichloride (BCl₃) for the aluminum alloy layer. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate electrodes (or conductors) in the optical stack 16 (such as the absorber layer 16a) from the conductive layers in the black mask structure 23.

FIG. 3E is another cross-sectional illustration of an IMOD display element, where the movable reflective layer 14 is self-supporting. While FIG. 3D illustrates support posts 18 that are structurally and/or materially distinct from the movable reflective layer 14, the implementation of FIG. 3E includes support posts that are integrated with the movable reflective layer 14. In such an implementation, the movable reflective layer 14 contacts the underlying optical stack 16 at multiple locations, and the curvature of the movable reflective layer 14 provides sufficient support that the movable reflective layer 14 returns to the unactuated position of FIG. 3E when the voltage across the IMOD display element is insufficient to cause actuation. In this way, the portion of the movable reflective layer 14 that curves or bends down to contact the substrate or optical stack 16 may be considered an “integrated” support post. One implementation of the optical stack 16, which may contain a plurality of several different layers, is shown here for clarity including an optical absorber 16a, and a dielectric 16b. In some implementations, the optical absorber 16a may serve both as a stationary electrode and as a partially reflective layer. In some implementations, the optical absorber 16a can be an order of magnitude thinner than the movable reflective layer 14. In some implementations, the optical absorber 16a is thinner than the reflective sub-layer 14a.

In implementations such as those shown in FIGS. 3A-3E, the IMOD display elements form a part of a direct-view device, in which images can be viewed from the front side of the transparent substrate 20, which in this example is the side opposite to that upon which the IMOD display elements are formed. In these implementations, the back portions of the device (that is, any portion of the display device behind the movable reflective layer 14, including, for example, the deformable layer 34 illustrated in FIG. 3C) can be configured and operated upon without impacting or negatively affecting the image quality of the display device, because the reflective layer 14 optically shields those portions of the device. For example, in some implementations a bus structure (not illustrated) can be included behind the movable reflective layer 14 that provides the ability to separate the optical properties of the modulator from the electromechanical properties of the modulator, such as voltage addressing and the movements that result from such addressing.

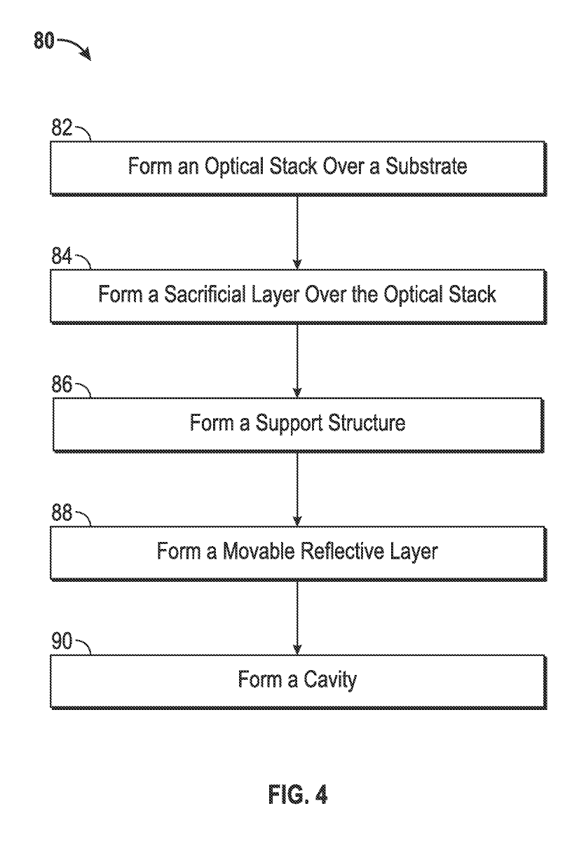

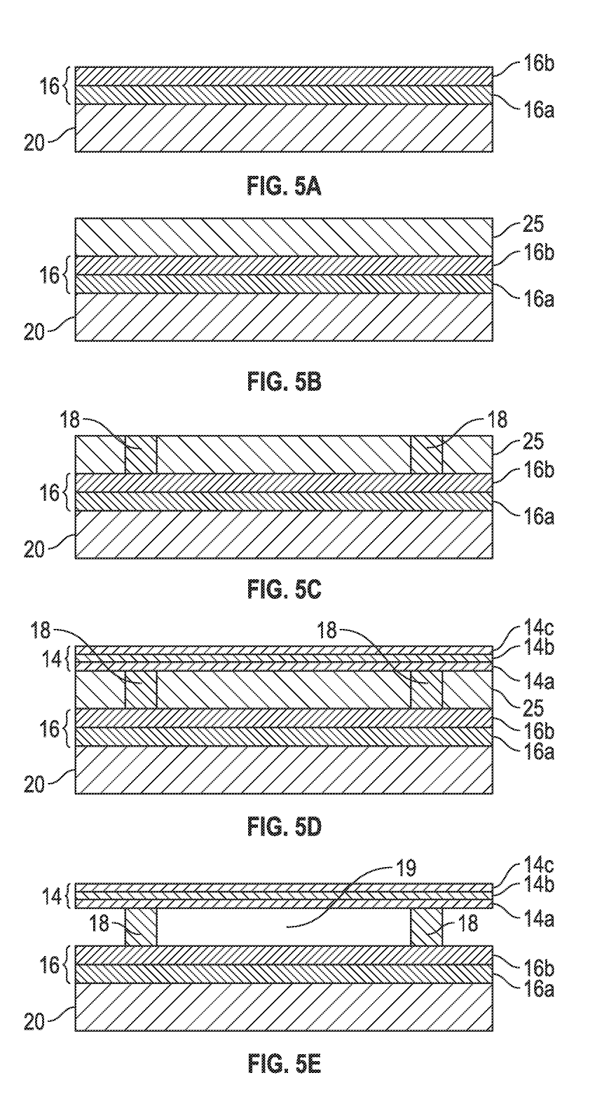

FIG. 4 is a flow diagram illustrating a manufacturing process 80 for an IMOD display or display element. FIGS. 5A-5E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 4. The process 80 begins at block 82 with the formation of the optical stack 16 over the substrate 20. FIG. 5A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 5A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 5A-5E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 5B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 5E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 5C, the aperture formed in the sacrificial layer 25 can extend through the sacrificial layer 25, but not through the optical stack 16. For example, FIG. 5E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 5C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 5D. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 5D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

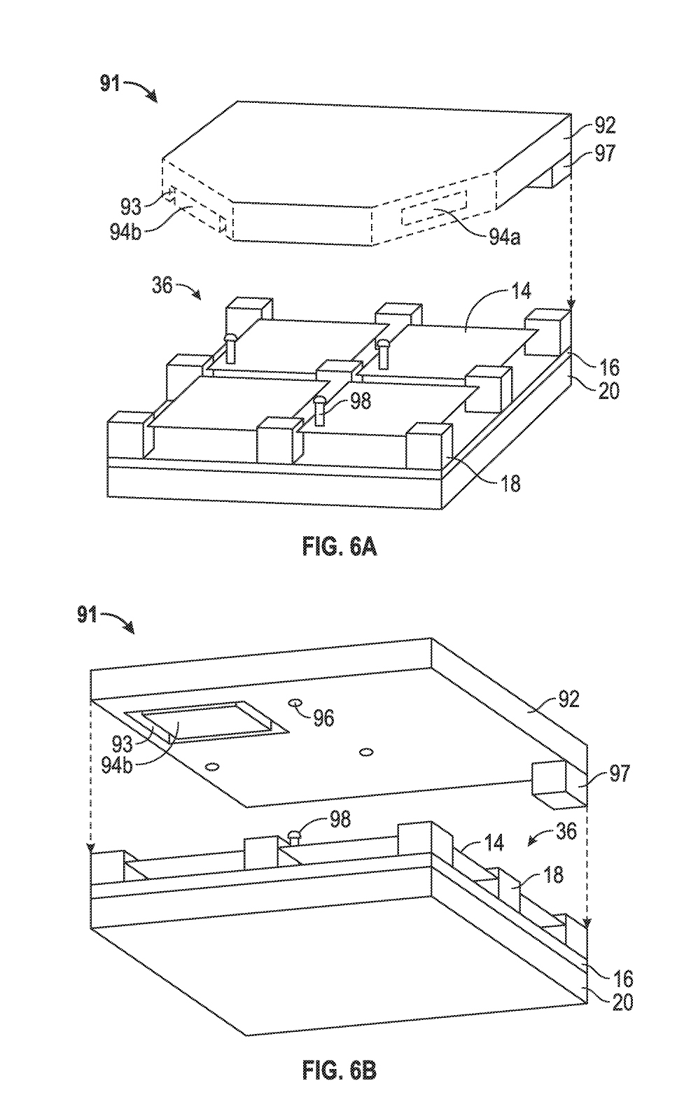

FIGS. 6A and 6B are schematic exploded partial perspective views of a portion of an EMS package 91 including an array 36 of EMS elements and a backplate 92. FIG. 6A is shown with two corners of the backplate 92 cut away to better illustrate certain portions of the backplate 92, while FIG. 6B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 6A and 6B, the backplate 92 can include one or more backplate components 94a and 94b, which can be partially or wholly embedded in the backplate 92. As can be seen in FIG. 6A, backplate component 94a is embedded in the backplate 92. As can be seen in FIGS. 6A and 6B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 6B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 6A and 6B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 6A and 6B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

FIG. 7 is a top plan view of an example patterned mask layer that defines an array of display elements, according to one implementation. As explained above with respect to FIG. 3D, the mask layer 23 may be a black mask structure that is optically opaque. In various implementations, the mask layer 23 can be electrically conductive and can transmit data signals to segment electrodes, such as electrode layers within the optical stack 16, such as the optical absorber 16a. FIG. 7 only illustrates the mask layer 23 for ease of illustration, but FIG. 3D above shows an example cross-section of the layers of the display element 12. For example, the spacer layer 35 may be deposited on the illustrated mask layer 23, and the optical stack 16 may be deposited on the spacer layer 35. The optical stack 16 may include one or more conductive electrode layers, such as optical absorber layer 16a, which can act as segment electrodes in the display array 900. The movable reflective layer 14 may be separated from the optical stack 16 by the air gap 19. The posts 18 may provide separation between the optical stack 16 and the movable reflective layer 14. In various implementations, the movable reflective layer 14 may act as the common electrodes when the optical stack 16 (or conductive layer(s) within the optical stack) acts as the segment electrodes. Thus, in some implementations described herein, the optical stack 16 also may be referred to as the segment electrode layer 16 or the segment electrode 16.

As explained above, the display element 12 can be actuated by applying a sufficiently high actuation voltage Vₐ across the conductive layers of the reflective layer 14 and the conductive optical absorber layer 16a of the segment electrode layer 16. Data signals may be routed to the display element 12 through the mask layer 23. Electrical signals passing through the mask layer 23 can electrically communicate with the conductive absorber layer 16a of the segment electrode layer 16 by way of vias formed in the insulating spacer layer 35.

The mask layer 23 can define the outlines of the display elements 12. For example, FIG. 7 shows a portion of a display array 900 that illustrates four rows of two display elements 12. Row 1 includes red display elements, R, having a red aperture area A_{R}. Row 2 includes first green display elements, G1, having a first green aperture area A_{G1}. Row 3 includes blue display elements, B, having a blue aperture area A_{B}. Row 4 includes second green display elements, G2, having a second green aperture area A_{G2}. In general, the aperture area may be defined at least in part by the area illuminated by the display element 12, which may be bounded by the mask layer 23. As shown in FIG. 7, the first green aperture area, A_{G1}, is larger than the second green aperture area, A_{G2}.

The display elements 12 may be arranged to form multiple pixels 33a and 33b. As shown in FIG. 7, a first pixel 33a may include a red display element R, a blue display element B, and two first green display elements G1. A second pixel 33b may include a red display element R, a blue display element B, and two second green display elements G2. It should be appreciated, however, that the illustrated portion of the display array 900 is only one example of how the display elements may be arranged to form pixels. For example, in other arrangements, the array may include first green display elements G1 adjacent to second green display elements G2 within a particular row. In yet other implementations, the green display elements G1 or G2 may be adjacent red R or blue B display elements within a particular row. Skilled artisans will understand that there are various ways to arrange display elements in a display array and that various pixel schemes may be used.

There are various reasons to design display elements of the same color to have different aperture areas. For example, image artifacts in certain displays (such as smartphones, tablets or other mobile device displays) may be reduced or eliminated by employing a binary weighted green pixel design. As shown in FIG. 7, two green display elements G1 and G2 may have the same pitch size in each pixel, but the first green display elements G1 may have a larger aperture area (e.g., fill factor), and the second green display elements G2 may have a smaller aperture area. When displaying colors, the larger aperture green display elements G1 have larger active areas, which may consequently be brighter than the green display elements G2 with the smaller apertures. Thus, each portion of the display may have green display elements having different aperture areas, one with a larger fill factor that is brighter (G1) and the other with a smaller fill factor that is dimmer (G2). By introducing differently-sized green display elements G1 and G2, richer image information can be displayed due to the additional green bit. For example, the human eye is typically more sensitive to the color green. By using two green display elements having different aperture areas to transmit different image data, the overall image appearance may be improved.

However, the size of the mask layer 23 may affect various display element parameters, including the stiffness associated with the electromechanical display element 12. The variance in stiffness may result in different actuation voltages for display elements 12 having different mask layer areas. As shown in FIG. 7, the portion of the mask layer 23 surrounding and associated with the first green display elements G1 has a smaller area than the portion of the mask layer 23 surrounding and associated with the second green display elements G2. The different mask layer patterns associated with the green display elements G1 and G2 may therefore cause the first green display elements G1 to have actuation voltages different from the actuation voltages for the second green display elements G2.

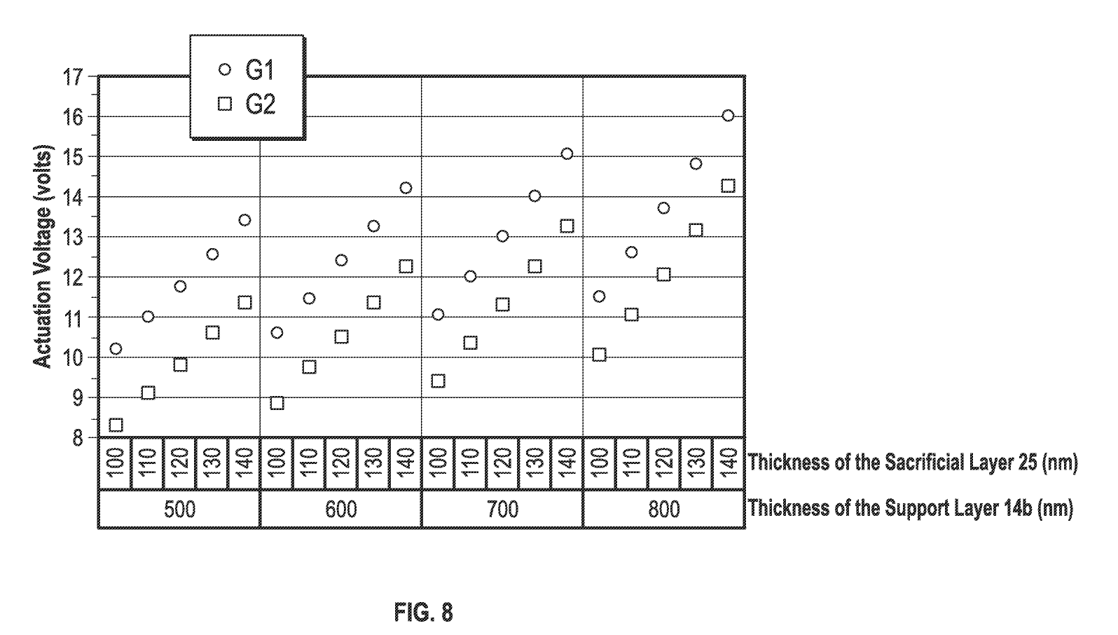

FIG. 8 is a graph plotting examples of actuation voltages of green display elements G1 and G2 having two different aperture areas (A_{G1} and A_{G2}) on the vertical axis, versus thicknesses of the support layer 14b and the sacrificial layer 25 on the horizontal axis. For each thickness value shown in FIG. 8, the actuation voltage associated with the first green display elements G1 is higher than the actuation voltage associated with the second green display elements G2. For example, as shown in FIG. 8, the actuation voltage difference between the two green display elements G1 and G2 may be as large as two volts for a wide range of associated layer thicknesses. In particular, the actuation voltage difference between the two green display elements G1 and G2 may be between about 1.8 volts and about 2.8 volts in some arrangements. The difference in actuation voltages for the green display elements G1 and G2 may cause undesirable image artifacts for various pixel driving schemes.

For example, in some arrangements, it may be desirable to simultaneously apply a write voltage waveform simultaneously across green display elements G1 and G2 in different rows in order to, for example, reduce a frame write time. If the actuation voltages for the green display elements G1 and G2 in the different rows are different, yet the voltage applied to the display elements G1 and G2 is the same, then the displayed color for the G1 display elements may be different from the displayed color for the G2 display elements. In other arrangements, however, the pixel design may call for first green display elements G1 to be adjacent second green display elements G2 in a particular row (or to otherwise be in the same row). If a common write voltage waveform is applied to a row having both types of green display elements G1 and G2, then the display elements G1 and G2 may display different colors, introducing image artifacts into the displayed image. It should be appreciated that undesirable image artifacts may be introduced in various other display arrangements and pixel schemes. Furthermore, although the differently-sized apertures are discussed herein with respect to green display elements, it should be appreciated that similar artifacts may result from red and/or blue display elements that have different aperture areas.

FIG. 9A is a top plan view of an example display element 12 having a segment electrode layer 16 disposed over a mask layer 23. In particular, the example display element 12 shown in FIG. 9A is a second green display element G2. The segment electrode layer 16 may correspond to the optical stack 16 shown in FIG. 3D, or it may refer to the conductive optical absorber layer 16a. As shown in FIG. 9A, the segment electrode layer 16 can be deposited over the mask layer 23 in a vertical strip or column. Data signals can be routed from the mask layer 23 to the electrode layer 16 by way of vias in the spacer layer 35 (see, e.g., FIG. 3D).

For ease of illustration, the movable reflective layer 14 is not shown in FIG. 9A. As explained above, however, the movable reflective layer 14 may be disposed above the segment electrode layer 16 in a horizontal strip or row. Thus, a particular display element 12 may be formed at an intersection of the segment electrode layer 16 and the movable reflective layer 14, which may act as a common electrode, or common line. For the particular display element 12, the portion of the segment electrode layer 16 associated with the particular display element 12 may define a segment electrode area under the common line or movable reflective layer 14 associated with the display element 12.

The segment electrode layer 16 may be patterned to define edge contours 31 that define the lateral boundaries for the segment electrode layer 16 for the display element G2 shown in FIG. 9A. For example, the edge contours 31 of the segment electrode layer 16 can include inwardly-directed notches 37 having a first radius r₁ formed near the corners of the display element 12. The area of the segment electrode layer 16 associated with the display element G2 may therefore be based in part on the radius r₁. As the radius r₁ of the notch 37 increases, the area of the segment electrode layer 16 under the common electrodes 14 of the particular display element 12 may decrease, because more material from the segment electrode layer 16 is removed. Although the notches 37 of the display element 12 shown in FIG. 9A are circular notches, it should be appreciated that any suitable shape for the notches may be used. For example, instead of using a circular notch, a rectangular, elliptical or triangular notch may be cut or formed in the electrode layer 17; still other notch shapes are possible. In the implementation of FIG. 9A, for example, the first radius r₁ may be about 7 μm. Conventionally, the same edge contours for the segment electrodes are associated with all the display elements R, G1, B and G2 of FIG. 7.

FIG. 9B is a top plan view of the example display element 12 of FIG. 9A with a segment electrode layer 16 having a smaller area associated with the display element than the segment electrode layer 16 shown in FIG. 9A. As explained above with reference to FIG. 8, because the first and second green display elements G1 and G2 have different mask layer areas and different aperture areas, the actuation voltage may be different for the display elements G1 and G2. Thus, the first green display elements G1 shown in FIG. 7 may have actuation voltages that are different from the actuation voltages for the second green display elements G2 shown in FIGS. 7 and 9A, and as evidenced in the graph of FIG. 8. The difference in actuation voltages may result in undesirable image artifacts for various pixel driving schemes, as explained above.

To reduce or eliminate the associated artifacts, various geometric and/or structural features of the display element 12 may be modified. For example, one model of an electromechanical display element, or IMOD, may be described by the following relationship between actuation voltage, Vₐ, and the material and geometric properties of the components of a display element:

$${V}_{a} = \sqrt{\frac{8}{27} \frac{k}{{ɛ}_{D} A} {( {g}_{0} + \frac{{t}_{d}}{{ɛ}_{τ}} )}^{3}} ,$$

where k is the stiffness of the display element 12, g₀ is the undriven air gap 19, ∈_{G} is the vacuum permittivity, t_{d} is the thickness of the dielectric layer 16b, ∈ᵣ is the relative dielectric constant of the dielectric layer 16b, and A is the electrode area, e.g., the area of the segment electrode layer 16 under the common line (or movable reflective layer 14) associated with a particular display element 12.

As shown from FIG. 8, the second green display elements G2 have actuation voltages that are less than the actuation voltages for the first green display elements G1. One way to match the actuation voltages for the display elements G1 and G2 and reduce image artifacts is to increase the actuation voltage for the second green display elements G2, for example by about two volts in the example of FIG. 8. From the relationship for Vₐ explained above, the actuation voltage may be increased in various ways. One way to increase the actuation voltage is to reduce the area A of the segment electrode layer 16 under the common line associated with the second green display element G2.

Thus, in FIG. 9B, the notches 37 may be formed to include a second radius r₂ that is larger than the first radius r₁. Indeed, as shown in FIG. 9B, the notches 37 may include portions that extend further inward than the notches having the first radius Because the notches 37 of FIG. 9B extend further inward than the notches 37 of FIG. 9A, the area of the segment electrode layer 16 associated with the display element 12 in FIG. 9B may be smaller than the area of the segment electrode layer 16 associated with the display element 12 in FIG. 9A. Because the segment electrode area is smaller in FIG. 9B than in FIG. 9A, the actuation voltage for the display element 12 in FIG. 9B may accordingly be higher than the actuation voltage for the display element 12 in FIG. 9A. From the relationship given above for Vₐ, the segment electrode area for the second green display elements G2 may be designed to match the actuation voltage for the first green display elements G1. In the implementation of FIG. 9B, for example, the second radius r₂ may be about 16 μm, which is larger than the 7 μm first radius r₁ associated with the second green display element G2 of FIG. 9A.

Thus, to match actuation voltages in various implementations, the segment electrodes of a first set of display elements may have a first area located under the common electrodes of the first set, and the segment electrodes of a second set of display elements may have a second area smaller than the first area located under the common electrodes of the second set. The variation in segment electrode areas may thereby match actuation voltages for display elements in the first and second sets. For example, the display elements of the first set may have larger apertures than the display elements of the second set (such as display elements G1 have larger apertures than display elements G2), which may induce various image artifacts for certain pixel driving schemes. Matching the actuation voltages for the display elements having differently-sized apertures can advantageously reduce or eliminate image artifacts caused by the different apertures. Moreover, while the discussion herein relates to two differently-sized green display elements, it should be appreciated that the principles disclosed herein can apply to display elements configured to display any other suitable color, such as, for example blue and/or red.

As shown in FIG. 9B, the segment electrode area may be modified by changing the size of the notches 37, which may take any suitable shape. In some other implementations, the edge contours 31 of the segment electrode layer 16 may be placed closer to the aperture to modify the area of the segment electrode 16 associated with the particular display element 12. In yet other implementations, the edge contours 31 can be cut or shaped in a periodic pattern to modify the area of the segment electrode layer 16 associated with the display element 12. Various other ways of modifying the segment electrode area associated with a particular display element are possible, such as placing holes in the segment electrode around the aperture, or notches in other positions.

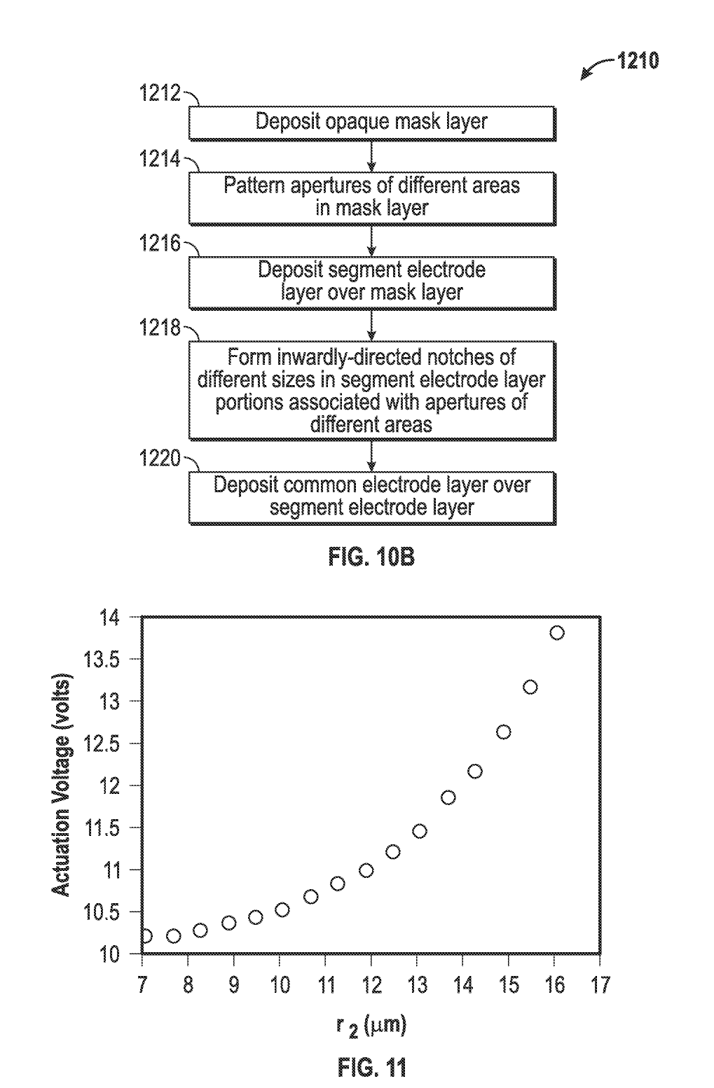

FIG. 10A is a flow diagram illustrating an example method 1200 of manufacturing a display. The method 1200 begins in a block 1202 to deposit an opaque mask layer. As shown in FIG. 3D, for example, the mask layer 23 may be deposited on the transparent substrate 20. As explained herein, the mask layer can define the outlines of the display elements in the array, and can serve to transmit data signals to the segment electrodes.

Turning to a block 1204, apertures may be defined in the mask layer. In some implementations, the apertures may be defined by edge contours of the mask layer. As above, it may be desirable to define apertures having different areas. For example, a first set of apertures may be defined in the mask layer to have a first area, and a second set of apertures may be defined in the mask layer to have a second area. The second set of apertures may have an area smaller than the apertures of the first set. In some implementations, green display elements can have apertures with different areas in order to improve image quality, as explained herein. For example, the apertures of the first green display elements G1 have larger apertures than the apertures of the second green display elements G2. The apertures may be defined in the mask layer by any suitable technique, such as by photolithographic techniques.

In block 1206, segment electrodes are deposited over the mask layer, wherein the segment electrodes have edge contours that are different for different apertures. As explained above, it can be desirable to form segment electrode areas to match actuation voltages in display elements having differently-sized apertures. For example, the edge contours of first portions of segment electrodes that overlie the apertures of the first set (defined in block 1204) can be defined. Edge contours of second portions of segment electrodes that overlie the apertures of the second set (defined in block 1204) may be defined to have a smaller area than the first portions of the segment electrodes that overlie the apertures of the first set. As explained above with respect to FIG. 9B, inwardly-directed notches may be formed in the segment electrodes to modify the segment electrode areas. For the second portions of segment electrodes that overlie the apertures of the second set, the notches may extend further inward than the first portions of segment electrodes that overlie the apertures of the first set.

FIG. 10B is a flow diagram illustrating another example method 1210 of manufacturing a display. As with FIG. 10A, the method 1210 begins in a block 1212 to deposit an opaque mask layer. As with FIG. 10A, the mask layer 23 may be deposited on the transparent substrate 20. In a block 1214, apertures are patterned in the opaque mask layer. For example, a first set of apertures can be patterned in the mask layer, and a second set of apertures also can be patterned in the mask layer. In some arrangements, the apertures defined in the first set can have a first area, and the apertures defined in the second set can have a second area. The second area can be smaller than the first area in various implementations. In various arrangements, the mask layer can be deposited on the substrate, and the apertures can be patterned by etching or any other suitable technique.

Turning to a block 1216, a segment electrode layer is deposited over the opaque mask layer. As explained herein with respect to FIGS. 3A-3E, the segment electrode layer can include multiple layers, including, for example an optical absorber layer and a dielectric layer. The method 1210 proceeds to a block 1218 to form inwardly-directed notches in the segment electrode layer. As explained herein, it can be advantageous to match the actuation voltage for display elements configured to display the same color and that have different aperture areas. By forming inwardly-directed notches in portions of the segment electrode layer that correspond to display elements having smaller aperture areas, the actuation voltage for the smaller aperture display elements may accordingly increase so as to approximately match the actuation voltage for larger aperture display elements configured to display the same color. In various implementations, the inwardly-directed notches may include a circular radius; in other implementations, notches of other shapes may be suitable.

In a block 1220, a common electrode layer is deposited over the segment electrode layer. As explained with respect to FIGS. 3A-3E, for example, the common electrode layer can include multiple layers. In various implementations, for example, the common electrode layer may correspond to a movable electrode layer. The common electrode layer also may include a reflective layer, a support layer, and a conductive layer, which may serve as an electrode in various implementations. The common electrodes can be deposited in a direction transverse to a direction in which the segment electrodes are deposited. A plurality of display elements can be defined at intersections of the common and segment electrodes.

FIG. 11 is a graph plotting actuation voltage of a display element versus the radius r₂ of a notch formed in an example segment electrode layer associated with the display element. In the example of FIG. 11, r₁ is about 7 μm. As the radius r₂ of the notch (such as the notch 37 in FIG. 9B) increases to be larger than r₁, the area of the segment electrode layer associated with the particular display element decreases, because the notch removes material from the electrode. Because actuation voltage Vₐ increases with decreasing segment electrode area, the actuation voltage Vₐ may therefore be higher for larger radii r₂.

For example, when both the first radius r₁ and the second radius r₂ of the second green display element G2 in FIG. 9A are both about 7 μm, this may correspond to an actuation voltage of about 10.2 volts in one example implementation. As explained herein with respect to the graph of FIG. 8, however, the actuation voltage for the first green display element G1 may be about 1.8 to 2.8 volts higher than the 10.2 volt actuation voltage of the second green display element G2 when both have r₁ and r₂ equal to about 7 μm. Because the actuation voltage of the second green display element G2 is not matched to the higher actuation voltage of the first green display element G1, image artifacts may occur when the same voltage is applied across both display elements G1 and G2.

To match the actuation voltages, the size of the notch may be increased in the segment electrode layer of the second green display element G2 to form a larger, second radius r₂, such as the second green display element G2 shown above in FIG. 9B. By increasing the second radius r₂, the actuation voltage of the second green display element G2 may be increased by several volts, easily more than the 1.8 to 2.8 volt difference observed with respect to FIG. 8. The increased second radius r₂ can thereby approximately match the actuation voltages for the first and second green display elements G1 and G2.

The second radius r₂ can be selected to achieve the desired actuation voltage. For example, in some example aperture arrangements, the maximum radius for the notch 37 may be about 16 μm, because larger notches may extend outside the mask layer 23 and into the aperture and affect optical performance. In such arrangements, because small increases in the notch radius can cause relatively large increases in actuation voltages, the radius r₂ of the notch can be less than 16 μm and still be capable of matching actuation voltages for the first and second green display elements G1 and G2. For example, if the actuation voltage of the first green display element G1 is about 12 volts with r₁₌r₂=7 μm, then, according to the graph of FIG. 11, selecting radius r₂ to be about 14 μm for G2 display elements would be sufficient to increase the actuation voltage of G2 to match the actuation voltage of G1. The above example is only one illustration of how to match actuation voltages; skilled artisans will appreciate that similar analyses may be applied for various other implementations.

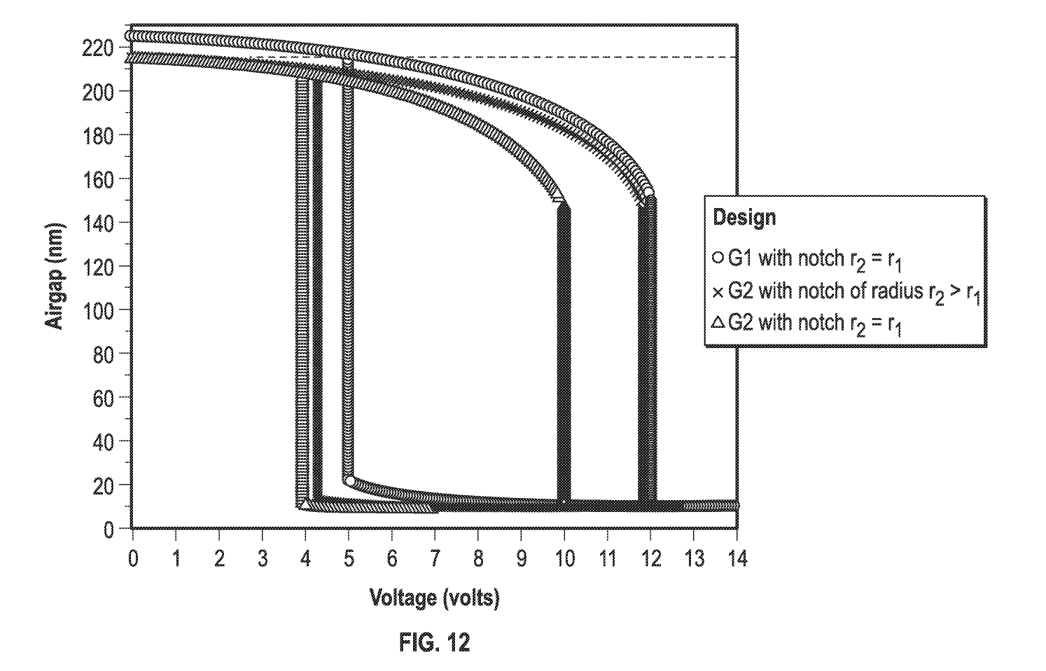

FIG. 12 is a graph plotting the air gap versus applied voltage for three different example green display elements. As shown in FIG. 12, the air gap is plotted for the first green display element G1 shown in FIG. 7, the second green display element G2 of FIG. 9A having a notch with second radius r₂ equal to the first radius r₁, and the second green display element G2 of FIG. 9B having a notch with the larger second radius r₂ greater than r₁. As shown in FIG. 12, the first green display element G1 of FIG. 7 may have an actuation voltage of about 12 volts in the illustrated implementation. Thus, the air gap actuates from about 150 nm to about 10 nm when a voltage of about 12 volts is applied to the first green display element G1. When the applied voltage drops to about 5 volts, the first green display element G1 may be released. Similarly, with the increased notch radius r₂ shown in FIG. 9B, the second green display element G2 also may actuate at an applied voltage of about 12 volts and may release at an applied voltage of between about 4 and 5 volts. Because the actuation voltages for the first green display element G1 and the second green display element G2 having the larger second radius r₂ are closely matched, image artifacts may be reduced. Furthermore, because the release voltage of the second green display element G2 having the larger second radius r₂ (such as about 4.2 volts) is less than the release voltage of the first green display element G1 (e.g., about 5 volts), the usable voltage window for passive driving of the second green display element G2 having the larger second radius r₂ overlaps the usable voltage window for passive driving of the first green display element G1. Accordingly, no side effects that might complicate a passive driving scheme are produced. By contrast, the usable voltage window for passive driving of the second green display element G2 having the second radius r₂ equal to the first radius r₁ mismatches, or does not overlap, the usable voltage window for passive driving of the first green display element G1. When applying a similar voltage to both green display elements G1 and G2 (having r₂=r₁), image artifacts may be produced. Indeed, the usable voltage window for both green display elements G1 and G2 (where r₂=r₁) may be reduced relative to the usable voltage window of either green display element alone.

The implementations disclosed herein may be realized in passive matrix displays or in active matrix displays. For passive matrix displays, in which display elements are actuated by applying signals to column and row electrodes, display elements having different aperture areas may be formed with different segment electrode areas to compensate for any resulting image artifacts. For example, as explained herein, edge contours for the segment electrodes may be defined to form a desired segment electrode area. Similarly, for active matrix displays, in which display elements are actuated by actuators located at each display element or pixel, the area of a segment electrode associated with a display element may similarly be modified to match actuation voltages of display elements having different actuation voltages. Skilled artisans will understand that the principles disclosed herein may be equally applicable for both passive and active matrix displays.

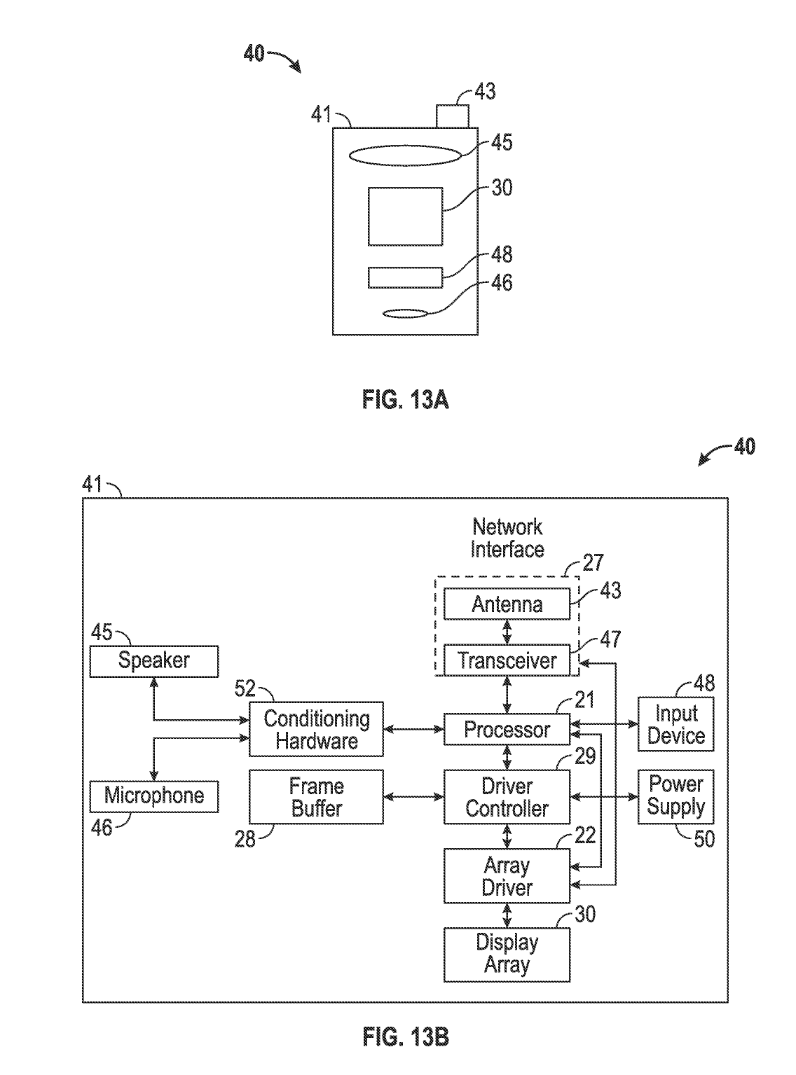

FIGS. 13A and 13B are system block diagrams illustrating an example display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 13A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 13A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus, comprising:
a plurality of electromechanical display elements including a first set of electromechanical display elements and a second set of electromechanical display elements, each electromechanical display element including a common electrode and a segment electrode,
wherein each of the segment electrodes of the first set of electromechanical display elements has a first area located under the common electrodes of the first set, and
wherein each of the segment electrodes of the second set of electromechanical display elements has a second area smaller than the first area located under the common electrodes of the second set.

2. The display apparatus of claim 1, wherein each electromechanical display element is associated with an actuation voltage, and wherein the actuation voltage of each electromechanical display element of the first set is approximately the same as the actuation voltage of each electromechanical display element of the second set.

3. The display apparatus of claim 1, wherein the plurality of electromechanical display elements are arranged in a plurality of rows, wherein the first set of electromechanical display elements are arranged along a first row, and wherein the second set of electromechanical display elements are arranged along a second row.

4. The display apparatus of claim 3, further comprising:
a plurality of common lines, each common line corresponding to one of the plurality of rows; and
a plurality of segment lines, wherein each segment electrode is associated with one of the plurality of segment lines,
wherein each electromechanical display element is in electrical communication with one of the plurality of common lines and one of the plurality of segment lines.

5. The display apparatus of claim 1, wherein each electromechanical display element has an aperture, and wherein the aperture of each electromechanical display element in the first set has a larger area than the aperture of each electromechanical display element in the second set.

6. The display apparatus of claim 5, wherein the electromechanical display elements in the first and second sets are configured to display substantially the same color.

7. The display apparatus of claim 6, wherein the electromechanical display elements in the first and second sets are configured to display green.

8. The display apparatus of claim 1, wherein the plurality of electromechanical display elements includes one or more interferometric modulators (IMODs).

9. The display apparatus of claim 1, wherein the plurality of electromechanical display elements forms a passive matrix array.

10. The display apparatus of claim 1, wherein the plurality of electromechanical display elements forms an active matrix array.

11. The display apparatus of claim 1, further comprising:
a processor that is configured to communicate with the display, the processor being configured to process image data; and
a memory device that is configured to communicate with the processor.

12. The display apparatus of claim 11, further comprising:
a driver circuit configured to send at least one signal to the display; and
a controller configured to send at least a portion of the image data to the driver circuit.

13. The display apparatus of claim 11, further comprising:
an image source module configured to send the image data to the processor, wherein the image source module includes at least one of a receiver, transceiver, and transmitter.

14. The display apparatus of claim 11, the display apparatus further comprising an input device configured to receive input data and to communicate the input data to the processor.

15. A method of manufacturing a display, comprising:
depositing an optically opaque mask layer on a substrate to define a plurality of apertures by edge contours of the mask layer; and
depositing segment electrodes over the mask layer and the apertures, the segment electrodes having edge contours that are different to define sets of physically different apertures.

16. The method of claim 15, further comprising:
defining a first set of apertures in the mask layer, each aperture in the first set having a first area; and
defining a second set of apertures in the mask layer, each aperture in the second set having a second area smaller than the first area.

17. The method of claim 16, wherein depositing the segment electrodes comprises:
defining the edge contours of first portions of the segment electrodes overlying apertures of the first set; and
defining the edge contours of second portions of the segment electrodes overlying apertures of the second set such that the first portions of the segment electrodes have a larger area than the second portions of the segment electrodes.

18. The method of claim 17, wherein defining the edge contours of the first portions includes forming inwardly-directed notches in the first portions of the segment electrodes, and wherein defining the edge contours of the second portions includes forming inwardly-directed notches in the second portions of the segment electrode, wherein the notches in the second portions extend further inward than the notches in the first portions.

19. The method of claim 18, wherein forming notches in the first portions includes forming notches having a first radius, and wherein forming notches in the second portions includes forming notches having a second radius larger than the first radius.

20. The method of claim 15, further comprising depositing common electrodes over and transverse to the segment electrodes to form a plurality of display elements at intersections of the common and segment electrodes.

21. The method of claim 20, wherein each of the display elements includes one aperture of the plurality of apertures, wherein a first set of display elements includes apertures having a first area, and wherein a second set of display elements includes apertures having a second area smaller than the first area.

22. The method of claim 21, wherein each display element is associated with an actuation voltage, and wherein the actuation voltage of each display element of the first set is approximately the same as the actuation voltage of each display element of the second set.

23. The method of claim 22, wherein the display elements in the first and second sets are configured to display substantially the same color.

24. The method of claim 23, wherein the electromechanical display elements in the first and second sets are configured to display green.

25. A display apparatus comprising:
a plurality of means for displaying image data, the displaying means comprising:
means for forming apertures having different sizes; and
means for reducing a disparity in an actuation voltage associated with the differently-sized apertures, the actuation voltage being configured to actuate the displaying means from an unactuated state to an actuated state.

26. The display apparatus of claim 25, wherein the aperture-forming means includes an optically opaque mask layer deposited on a substrate to define the differently-sized apertures by edge contours of the mask layer.

27. The display apparatus of claim 26, wherein the disparity-reducing means includes segment electrodes deposited over the mask layer and the apertures, the segment electrodes having edge contours that are shaped differently for differently-sized apertures.

28. The display apparatus of claim 27, further comprising:
a first set of apertures in the mask layer, each aperture having a first area; and
a second set of apertures in the mask layer, each aperture having a second area smaller than the first area.

29. The display apparatus of claim 28, wherein edge contours of first portions of the segment electrodes overlie apertures of the first set, and wherein edge contours of second portions of the segment electrodes overlie apertures of the second set, the first portions of the segment electrodes having a larger area than the second portions of the segment electrodes.

30. The display apparatus of claim 27, wherein the plurality of displaying means further includes a plurality of common electrodes disposed over and transverse to the segment electrodes.

31. The display apparatus of claim 25, wherein the displaying means includes a plurality of electromechanical display elements.

32. The display apparatus of claim 31, wherein the plurality of electromechanical display elements includes a plurality of interferometric modulators (IMODs).
